(19) United States
(12) Patent Application Publication
(10) Pub. No.: US 2019/0170001 A1
(43) Pub. Date: Jun. 6, 2019

(54) IMPINGEMENT COOLING OF A BLADE PLATFORM

(71) Applicant: SIEMENS AKTIENGESELLSCHAFT, München (DE)

(72) Inventors: Dawid Frach, Lincoln (GB); Kexin Liu, Lincoln (GB)

(73) Assignee: Siemens Aktiengesellschaft, Munich (DE)

(21) Appl. No.: 16/314,911

(22) PCT Filed: Jul. 14, 2017
(86) PCT No.: PCT/EP2017/067938

§ 371 Date: Jan. 3, 2019

(30) Foreign Application Priority Data
Jul. 18, 2016 (EP) 16179848.3

(51) Int. Cl. F01D 5/18

(52) U.S. Cl. CPC F01D 5/187; F05D 2220/32; F05D 2260/201; F05D 2240/81

(57) ABSTRACT

A turbomachine component includes an aerofoil and a platform. The aerofoil has a pressure and a suction side that meet at a trailing and a leading edge. The platform includes an aerofoil side wherefrom the aerofoil extends radially, an opposite side, and a cavity positioned in an overhang region of the platform. The cavity has an aerofoil-side cavity wall along the aerofoil side and a plurality of impingement plates arranged successively along an axial direction within the cavity. Each impingement plate includes a central plate including impingement holes in-between a flow-input-side part and an aerofoil-side part connected to the aerofoil-side cavity wall. Each impingement plate defines an aerofoil-side and a flow-input-side segment. Within the cavity, cooling air flows from the flow-input-side segment through the impingement holes to the aerofoil-side segment of one impingement plate and therefrom to the flow-input-side segment of a subsequent impingement plate.

### CROSS REFERENCE TO RELATED APPLICATIONS

This application is the US National Stage of International Application No. PCT/EP2017/067938 filed Jul. 14, 2017, and claims the benefit thereof. The International Application claims the benefit of European Application No. EP16179848 filed Jul. 18, 2016. All of the applications are incorporated by reference herein in their entirety.

### FIELD OF INVENTION

The present invention relates to turbomachine components having an aerofoil, and more particularly to cooling of platform of a turbomachine component having an aerofoil, particularly a vane platform or a blade platform, in gas turbine engines.

### BACKGROUND OF INVENTION

To effectively use cooling air for cooling of gas turbine components is a constant challenge and an important area of interest in gas turbine engine designs. For example, for cooling different parts of a turbomachine component having an aerofoil, such as a vane or a blade, conventional design uses various ways including film cooling and circulation of cooling fluid through different parts of the vane or the blade. However, the conventional designs are inefficient in effectively cooling all parts of the vane or the blade of the turbomachine, for example the conventional designs are inept at cooling certain parts of the platform of the vanes and/or the blades.

A turbine vane generally includes an inner platform and an outer platform, whereas a turbine blade usually has only one platform and may optionally have a shroud. When installed in a gas turbine engine, the inner platform of the turbine vane is usually connected to or fixed to a stationary turbine component positioned towards the rotational axis of the turbine such as a turbine vane carrier ring or a stator. Several turbine vanes may be fixed to a given turbine vane carrier ring. Similarly, the outer platform of the turbine vane is fixed to another stationary component of the turbine towards an outer casing of the turbine. Similarly, the platform of the turbine blade is fixed to rotating disks or discs mounted on a main shaft of the turbine. Several turbine blades are fixed to a given rotating disc. To be arranged properly around a given turbine vane carrier ring or a given rotating disc, the platforms of the turbine vanes or the turbine blades are usually axially extending beyond the region of the platform required to support the aerofoil and thus forming platform overhangs next to the leading edge and/or the trailing edge of the aerofoil. Such platform overhangs are prominently present in guide vanes of a gas turbine. Usually, in a gas turbine, any platform in a turbomachine component having an aerofoil has one or more platform overhangs.

U.S. Pat. No. 4,573,865 discloses a multiple-impingement cooled structure, such as for use as a turbine shroud assembly. The structure includes a plurality of baffles which define with an element to be cooled, such as a shroud, a plurality of cavities. Impingement cooling air is directed through holes in one of the baffles to impinge upon only the portion of the shroud in a first cavity. That cooling air is then directed to impinge again upon the portion of the shroud in a second cavity.

In the present description the turbine vane of a gas turbine has been used as an example of a turbomachine component having an aerofoil, however, it may be noted that for the purposes of the present technique, examples of the turbomachine component having an aerofoil also include the blade of a gas turbine. In the conventional design certain regions of the platforms of such turbomachine component having an aerofoil, hereinafter also referred to as the vane or the turbomachine component, are cooled, for example the region of the platform that is directly covered by the aerofoil has cavities through which cooling fluid flows into the aerofoil and thus the region of the platform bordering the cavity is cooled by the flow of the cooling fluid. However, the platform overhangs adjacent to the region of the platform directly beneath or above the aerofoil are not subjected to efficient cooling and thus prone to failure under the high operational temperatures and corroding effects of the hot gases coming from the combustor section when the turbine is operated. Thus there is a need to provide a technique to cool the platform overhangs, particularly side of the platform overhang that are in or towards hot gas path in the gas turbine.

### SUMMARY OF INVENTION

Thus an object of the present disclosure is to provide a technique wherein the platform overhangs are cooled efficiently. It is desirable to cool side of the platform overhangs that are in or towards the hot gas path in the gas turbine.

The above objects are achieved by a turbomachine component and an array of turbomachine components of the present technique. Advantageous embodiments of the present technique are provided in dependent claims. Features of independent claims may be combined with features of dependent claims, and features of dependent claims can be combined together.

In an aspect of the present technique, a turbomachine component, particularly a blade or a vane for a gas turbine engine, is presented. The turbomachine component includes an aerofoil and a first platform. The first platform extends both circumferentially and axially. The aerofoil has a pressure side and a suction side that meet at a trailing edge and a leading edge. The first platform includes an aerofoil side wherefrom the aerofoil extends radially, an opposite side of the aerofoil side, and a first-platform cavity positioned in a first overhang region of the first platform. The first-platform cavity extends within the first platform and includes an aerofoil-side cavity wall along the aerofoil side and a plurality of impingement plates. The first platform cavity extends circumferentially and axially. The impingement plates are arranged successively in an axial direction within the first-platform cavity. Each impingement plate includes an aerofoil-side part, a flow-input-side part and a central plate.

The aerofoil-side part extends towards and is connected to the aerofoil-side cavity wall of the first-platform cavity. The flow-input-side part extends towards a direction opposite to the aerofoil-side cavity wall of the first-platform cavity. The central plate is between the aerofoil-side part and the flow-input-side part, and is suspended by the aerofoil-side part and the flow-input-side part in the first-platform cavity. The central plate is suspended, extending circumferentially and axially, along the aerofoil-side cavity wall such that the impingement plate defines, within the first-platform cavity in a radial direction, an aerofoil-side segment and a flow-input-side segment corresponding to said impingement plate. The central plate has impingement holes such that cooling air entering the first-platform cavity flows within the first-platform cavity from the flow-input-side segment of one impingement plate through the impingement holes to the aerofoil-side segment of said impingement plate as impingement jets, and thus cooling the aerofoil-side cavity wall along the aerofoil side of the first platform, which in turn results in the cooling of the aerofoil side of the first platform. Subsequently, the cooling air from the aerofoil-side segment of said impingement plate flows to the flow-input-side segment of a following impingement plate. From the flow-input-side segment of the following impingement plate the cooling air flows through the impingement holes of said following impingement plate as impingement jets towards the aerofoil-side cavity wall of the first-platform cavity, thus cooling of the aerofoil side of the first platform, and therefrom to the flow-input-side segment of a subsequent following impingement plate.

In turbomachine component, particularly in the first-platform cavity, as a result of the serially arranged impingement plates, two pockets of air corresponding to each impingement plate are created in sections of the first-platform cavity corresponding to each of the serially arranged impingement plates, namely the flow-input-side segment and the aerofoil-side segment. The flow-input-side segment and the aerofoil-side segment are in fluid communication through the impingement holes of the impingement plate creating the flow-input-side and the aerofoil-side segments. As a net result of all the impingement plates, a series of flow-input-side segments and aerofoil-side segments are created i.e. for example a flow-input-side segment of a first impingement plate fluidly connected to an aerofoil-side segment of the first impingement plate which in turn is fluidly connected to a flow-input-side segment of a second impingement plate which in turn is fluidly connected to an aerofoil-side segment of the second impingement plate which in turn is fluidly connected to a flow-input-side segment of a third impingement plate and so on and so forth. As an effect of the flow of the cooling air serially flowing through the impingement plates so arranged in the first-platform cavity buildup of strong cross flow with respect to impingement jets corresponding to a given impingement plate is minimized and thus the impingement jets are able to reach the aerofoil-side cavity wall of the first-platform cavity and provide effective cooling to the aerofoil side within the first overhang region of the first platform. Furthermore, sizes of the impingement holes can be controlled individually for different impingement plates and thus parameters of the impingement jets produced by different impingement plates, such as velocity of the impingement jets, can be controlled and thereby different degrees of cooling can be achieved locally for different impingement plates.

Moreover, since all the cooling air passes through the impingement holes of every impingement plate, individually and serially, the entire volume of the cooling air is used to serially cool each of the different sections of the aerofoil side within the first overhang region of the first platform created by the different impingement plates, and thus less cooling air is required to cool the aerofoil side within the first overhang region of the first platform.

In an embodiment of the turbomachine component, the first-platform cavity includes an opposite-side cavity wall along the opposite side of the first platform and the flow-input-side part of the impingement plate arranged within the first-platform cavity is connected to the opposite-side cavity wall.

In another embodiment of the turbomachine component, the first platform includes an additional first-platform cavity positioned in a second overhang region of the first platform. The additional first-platform cavity extends circumferentially and axially within the first platform and includes an aerofoil-side cavity wall along the aerofoil side and a plurality of impingement plates arranged similarly as the impingement plates are arranged in the first-platform cavity. Thus cooling is provided to second overhang region of the first platform.

In another embodiment of the turbomachine component, the additional first-platform cavity includes an opposite-side cavity wall along the opposite side of the first platform and the flow-input-side part of each of the impingement plates arranged within the additional first-platform cavity is connected to the opposite-side cavity wall.

In another embodiment of the turbomachine component, the first overhang region of the first platform is downstream of the trailing edge when viewed from the leading edge towards the trailing edge, and optionally the second overhang region of the first platform is upstream of the leading edge. In another embodiment of the turbomachine component, the first overhang region of the first platform is downstream of the leading edge when viewed from the trailing edge towards the leading edge, and optionally the second overhang region of the first platform is upstream of the leading edge.

In another embodiment of the turbomachine component, such as when the turbomachine component is a turbine vane, the turbomachine component includes a second platform. The second platform extends circumferentially and axially. The second platform includes an aerofoil side whereto the radially extending aerofoil extends, an opposite side of the aerofoil side, and a second-platform cavity positioned in a first overhang region of the second platform. The second-platform cavity extends circumferentially and axially within the second platform and includes an aerofoil-side cavity wall along the aerofoil side, and a plurality of impingement plates arranged similarly as the impingement plates are arranged in the first-platform cavity of the first platform. Thus cooling is provided to the second platform, for example the outer platform of a turbine vane.

In another embodiment of the turbomachine component, the second-platform cavity includes an opposite-side cavity wall along the opposite side of the second platform and the flow-input-side part of the impingement plate arranged within the second-platform cavity is connected to the opposite-side cavity wall.

In another embodiment of the turbomachine component, the second platform includes an additional second-platform cavity positioned in a second overhang region of the second platform. The additional second-platform cavity extends circumferentially and axially within the second platform and includes an aerofoil-side cavity wall along the aerofoil side and a plurality of impingement plates arranged similarly as the impingement plates are arranged in the second-platform cavity.

In another embodiment of the turbomachine component, the additional second-platform cavity includes an opposite-side cavity wall along the opposite side of the second platform and the flow-input-side part of each of the impingement plates arranged within the additional second-platform cavity is connected to the opposite-side cavity wall.

In another embodiment of the turbomachine component, the first overhang region of the second platform is downstream of the trailing edge when viewed from the leading edge towards the trailing edge, and optionally the second overhang region of the second platform is upstream of the leading edge.

In another embodiment of the turbomachine component, the first overhang region of the second platform is downstream of the leading edge when viewed from the trailing edge towards the leading edge, and optionally the second overhang region of the second platform is upstream of the leading edge.

Another aspect of the present technique presents an array of turbomachine components, such as turbine vanes or turbine blades for a gas turbine. The array includes a plurality of turbomachine components having aerofoils and a turbomachine components carrying ring. Each of the turbomachine components having aerofoils is circumferentially arranged on the turbomachine components carrying ring. The plurality of turbomachine components having aerofoils includes at least one turbomachine component according to the aspect of the present technique presented hereinabove.

In an embodiment of the array, the turbomachine components having aerofoils are blades for the gas turbine engine and the turbomachine components carrying ring is a rotor disc for the gas turbine engine.

In another embodiment of the array, the turbomachine components having aerofoils are vanes of the gas turbine engine and the turbomachine components carrying ring is a vane carrier ring of the gas turbine engine.

### BRIEF DESCRIPTION OF THE DRAWINGS

The above mentioned attributes and other features and advantages of the present technique and the manner of attaining them will become more apparent and the present technique itself will be better understood by reference to the following description of embodiments of the present technique taken in conjunction with the accompanying drawings, wherein:

FIG. 1 shows part of an exemplary turbine engine in a sectional view and in which an exemplary embodiment of a turbomachine component of the present technique is to be incorporated;

FIG. 2 schematically illustrates an exemplary embodiment of a segment of the turbine engine of FIG. 1 in a sectional view and in which an exemplary embodiment of the turbomachine component of the present technique is to be incorporated;

FIG. 3 schematically illustrates an exemplary embodiment of a segment of the turbine engine of FIG. 2 in a sectional view and in which an exemplary embodiment of the turbomachine component of the present technique is incorporated;

FIG. 4 schematically illustrates another exemplary embodiment of the turbomachine component with a first-platform cavity according to the present technique;

FIG. 5 schematically illustrates another exemplary embodiment of the turbomachine component with an additional first-platform cavity according to the present technique;

FIG. 6 schematically illustrates another exemplary embodiment of the turbomachine component with the first-platform cavity having another shape as compared to the first-platform cavity of FIG. 4;

FIG. 7 schematically illustrates another exemplary embodiment of the turbomachine component with the first-platform cavity having another shape as compared to the first-platform cavity of FIG. 6;

FIG. 8 schematically illustrates a cross-sectional view of an exemplary embodiment of a first platform of the turbomachine component when viewed in a radial direction;

FIG. 9 schematically illustrates a cross-sectional view of another exemplary embodiment of the first platform of the turbomachine component when viewed in the radial direction;

FIG. 10 schematically illustrates another exemplary embodiment of the turbomachine component with a second-platform cavity according to the present technique;

FIG. 11 schematically illustrates another exemplary embodiment of the turbomachine component with an additional second-platform cavity according to the present technique;

FIG. 12 schematically illustrates a cross-sectional view of an exemplary embodiment of a second platform of the turbomachine component when viewed in the radial direction;

FIG. 13 schematically illustrates a cross-sectional view of another exemplary embodiment of the second platform of the turbomachine component when viewed in the radial direction;

FIG. 14 schematically illustrates cooling air flow within the first-platform cavity of the exemplary embodiment of the turbomachine component depicted in FIG. 3;

FIG. 15 schematically illustrates an exemplary embodiment of an arrangement of impingement plates within the first-platform cavity of the exemplary embodiment of the turbomachine component depicted in FIG. 3;

FIG. 16 schematically illustrates an exemplary embodiment of an impingement plate from the arrangement of impingement plates within the first-platform cavity as depicted in FIG. 15;

FIG. 17 schematically illustrates another exemplary embodiment of the impingement plate;

FIG. 18 schematically illustrates arrangement of impingement plates in the second-platform cavity and cooling air flow within the second-platform cavity of the exemplary embodiment of the turbomachine component depicted in FIG. 10;

FIG. 19 schematically illustrates an array of turbomachine components; and

FIG. 20 schematically illustrates the first platforms of the turbomachine components of the array; in accordance with aspects of the present technique.

### DETAILED DESCRIPTION OF INVENTION

Hereinafter, above-mentioned and other features of the present technique are described in details. Various embodiments are described with reference to the drawing, wherein like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the invention. It may be evident that such embodiments may be practiced without these specific details.

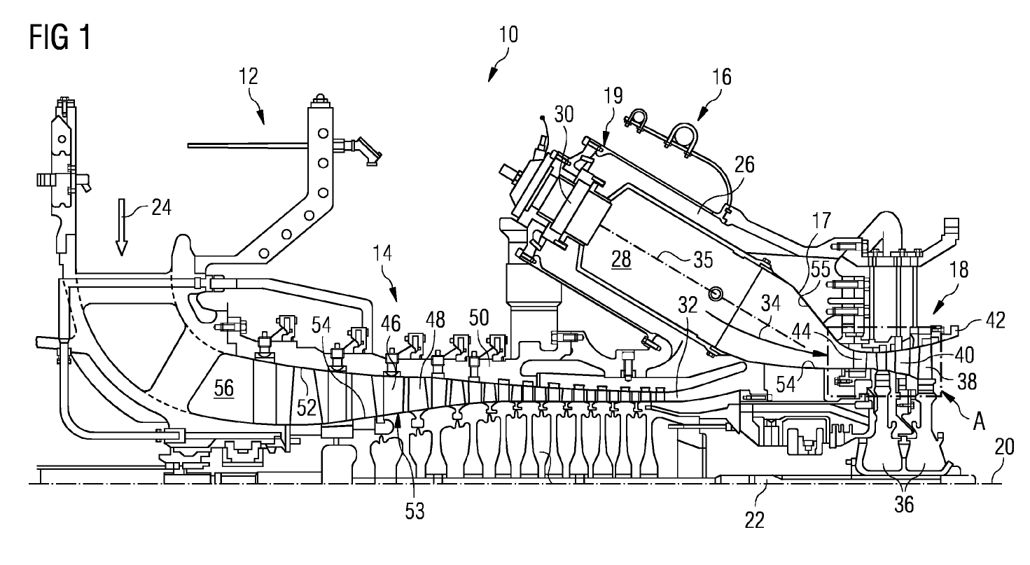

FIG. 1 shows an example of a gas turbine engine 10 in a sectional view. The gas turbine engine 10 comprises, in flow series, an inlet 12, a compressor or compressor section 14, a combustor section 16 and a turbine section 18 which are generally arranged in flow series and generally about and in the direction of a rotational axis 20. The gas turbine engine 10 further comprises a shaft 22 which is rotatable about the rotational axis 20 and which extends longitudinally through the gas turbine engine 10. The shaft 22 drivingly connects the turbine section 18 to the compressor section 14.

In operation of the gas turbine engine 10, air 24, which is taken in through the air inlet 12 is compressed by the compressor section 14 and delivered to the combustion section or burner section 16. The burner section 16 comprises a burner plenum 26, one or more combustion chambers 28 extending along a longitudinal axis 35 and at least one burner 30 fixed to each combustion chamber 28. The combustion chambers 28 and the burners 30 are located inside the burner plenum 26. The compressed air passing through the compressor 14 enters a diffuser 32 and is discharged from the diffuser 32 into the burner plenum 26 from where a portion of the air enters the burner 30 and is mixed with a gaseous or liquid fuel. The air/fuel mixture is then burned and the combustion gas 34 or working gas from the combustion is channelled through the combustion chamber 28 to the turbine section 18 via a transition duct 17. An inner surface 55 of the transition duct 17 defines a part of the hot gas path.

This exemplary gas turbine engine 10 has a cannular combustor section arrangement 16, which is constituted by an annular array of combustor cans 19 each having the burner 30 and the combustion chamber 28, the transition duct 17 has a generally circular inlet that interfaces with the combustor chamber 28 and an outlet in the form of an annular segment. An annular array of transition duct outlets form an annulus for channelling the combustion gases to the turbine 18.

The turbine section 18 comprises a number of blade carrying discs 36 attached to the shaft 22. In the present example, two discs 36 each carry an annular array of turbine blades 38. However, the number of blade carrying discs could be different, i.e. only one disc or more than two discs. In addition, guiding vanes 40, which are fixed to a stator 42 of the gas turbine engine 10, are disposed between the stages of annular arrays of turbine blades 38. Between the exit of the combustion chamber 28 and the leading turbine blades 38 inlet guiding vanes 44 are provided and turn the flow of working gas onto the turbine blades 38.

The combustion gas 34 from the combustion chamber 28 enters the turbine section 18 and drives the turbine blades 38 which in turn rotate the shaft 22. The guiding vanes 40, 44, hereinafter also referred to as the vanes 40,44, serve to optimise the angle of the combustion or working gas 34 on the turbine blades 38.

The turbine section 18 drives the compressor section 14. The compressor section 14 comprises an axial series of vane stages 46 and rotor blade stages 48. The rotor blade stages 48 comprise a rotor disc supporting an annular array of blades. The compressor section 14 also comprises a casing 50 that surrounds the rotor stages and supports the vane stages 48. The guide vane stages include an annular array of radially extending vanes that are mounted to the casing 50. The vanes are provided to present gas flow at an optimal angle for the blades at a given engine operational point. Some of the guide vane stages have variable vanes, where the angle of the vanes, about their own longitudinal axis, can be adjusted for angle according to air flow characteristics that can occur at different engine operations conditions.

The casing 50 defines a radially outer surface 52 of the passage 56 of the compressor 14. A radially inner surface 54 of the passage 56 is at least partly defined by a rotor drum 53 of the rotor which is partly defined by the annular array of blades 48.

The present technique is described with reference to the above exemplary turbine engine having a single shaft or spool connecting a single, multi-stage compressor and a single, one or more stage turbine. However, it should be appreciated that the present technique is equally applicable to two or three shaft engines and which can be used for industrial, aero or marine applications. Furthermore, the cannular combustor section arrangement 16 is also used for exemplary purposes and it should be appreciated that the present technique is equally applicable to annular type and can type combustion chambers.

The terms upstream and downstream refer to the flow direction of the airflow and/or working gas flow 34 through the engine unless otherwise stated. The terms forward and rearward refer to the general flow of gas through the engine. The terms axial, axially, axial direction, radial, radially, radial direction, circumferential, circumferentially and circumferential direction are made with reference to the rotational axis 20 of the engine, unless otherwise stated. The phrase a first element “along” a second element, and like phrases, means the first element runs or extends or is arranged in the same directions as the second element, i.e. for example to explain further, if the second element is a surface or a side and extends in x-z coordinates in Cartesian coordinate system then the first element “along” the second element means the first element also extends in x-z coordinate albeit the first element may be removed by a distance from the second element in x coordinate and/or in z coordinate. Simply put, the first element “along” the second element may be understood as the first element extending in such dimensions as to be parallel or substantially parallel to the second element for example the first element and the second element may form an angle between 0 degree and 20 degree.

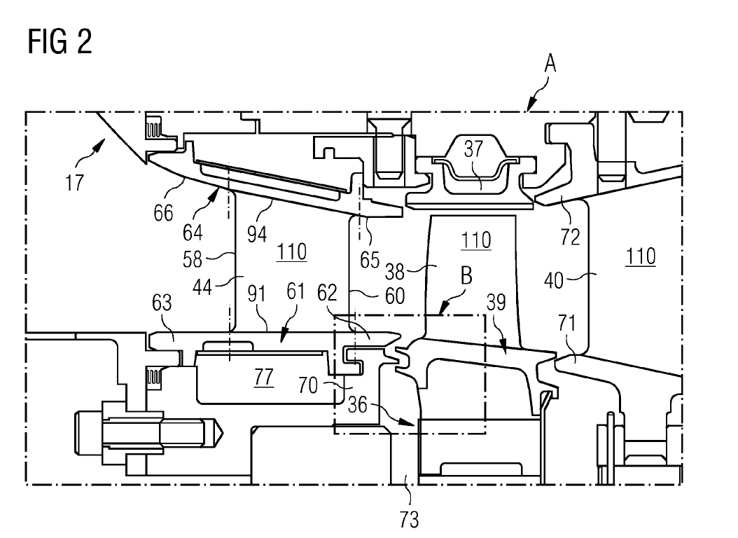

FIG. 2 provides a more detailed view of a region ‘A’ of FIG. 1 and gives an exemplary position in the turbine section 18, including a junction of the combustor 16 and the turbine section 18, where the present technique may be implemented. In FIG. 2, turbomachine components having aerofoil for example the inlet guiding vane 44, the turbine blade 38, and the guiding vane 40 are represented schematically in parts. In the gas turbine engine 10, the inlet guiding vane 44 is fixed to a vane carrying ring 70 which may be part of the stator 42 and the turbine blade 38 is fixed to the blade carrying disc 36. Hereinafter for purposes of explanation the inlet guiding vane 44 has been used but it may be appreciated by one skilled in the art of turbomachines that the present technique is also applicable to the turbine blade 38, and the guiding vane 40.

The inlet guiding vane 44, hereinafter also referred to the vane 44, has an aerofoil 110 extending from an inner platform 61, arranged towards the rotational axis 20, which in turn is adapted to be connected, or is connected when the vane 44 is installed within the gas turbine engine 10, to the vane carrying ring 70. The aerofoil 110 has a leading edge 58 and a trailing edge 60. The aerofoil 110 covers a part 91 of the inner platform 61, i.e. the part of the inner platform 61 that lies directly beneath the aerofoil 110, however one or more other parts 62, 63 of the inner platform 61 extend beyond the part 91 of the inner platform 61 that lies directly beneath, or in direct contact with, the aerofoil 110 and thereby form a first overhang 62 downstream of the trailing edge 60 and a second overhang 63 upstream of the leading edge 58. Similarly the turbine blade 38 has a platform 39 and the guiding vane 40 has an inner platform 71 and one or both of the platform 39 and the inner platform 71 may have one or more overhangs (not shown). The turbine blade 38 may have a heat shield 37 on the other end.

Conventionally, cooling air is fed from internal cooling channels (not shown) and through the platforms 61, 39, 71, into the aerofoils 110 of the vane 40, turbine blade 38 and the guiding vane 40, for example through a space 77 beneath the platform 61 and then through part 91 into the aerofoil 110 of the vane 44, though it has not been depicted in FIG. 2 for sake of simplicity.

The vane 44 also has an outer platform 64 to which the aerofoil 110 extends. The aerofoil 110 covers a part 94 of the outer platform 64, i.e. the part of the outer platform 64 that lies directly above, or in direct contact with, the aerofoil 110, however one or more other parts 65, 66 of the outer platform 64 extend beyond the part 94 of the outer platform 64 and thereby form a first overhang 65 downstream of the trailing edge 60 and a second overhang 66 upstream of the leading edge 58. Similarly the guiding vane 40 has an outer platform 72 and may have similar overhangs in the outer platform 72.

The present technique is implemented in one or more overhangs 62,63,65,66 of the vane 44 or similar overhangs (not shown) of the platforms 39, 71, 72 of the turbine blade 38 and the guiding vane 40.

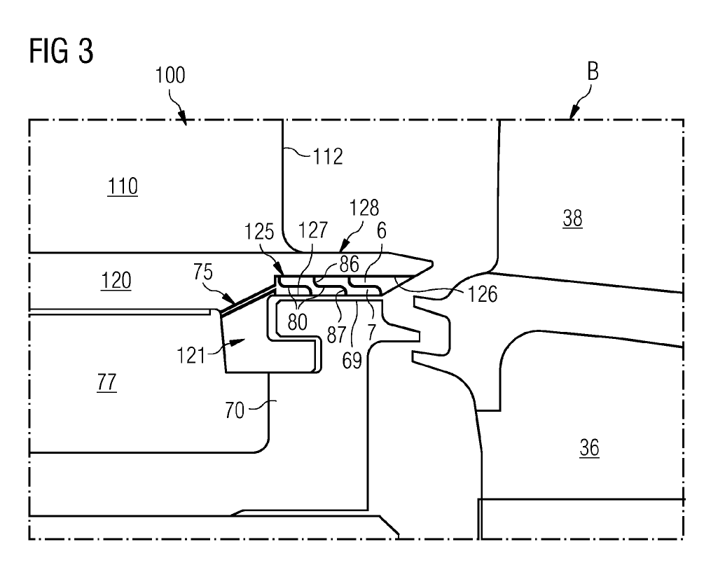

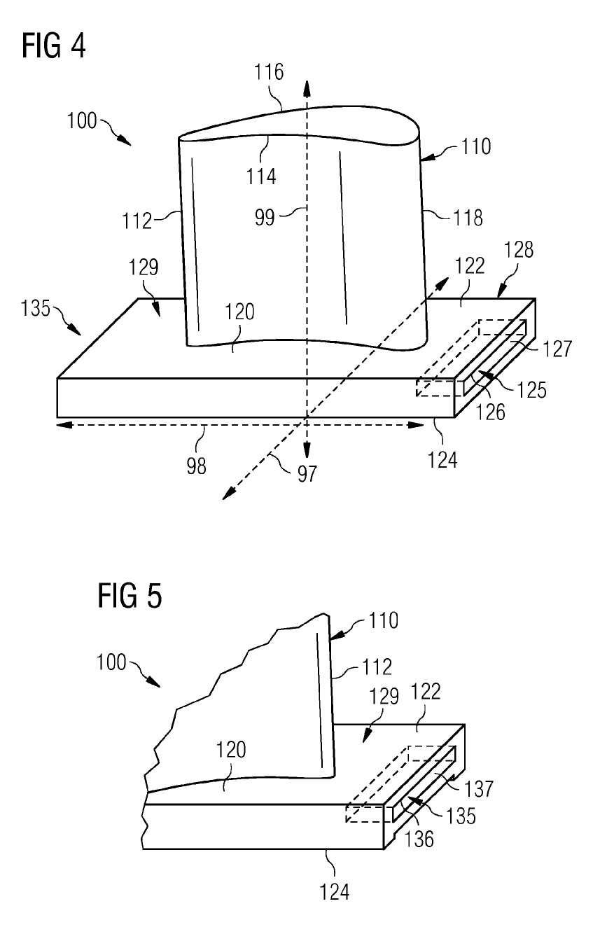

FIG. 3 in combination with FIGS. 4 to 9, schematically presents an exemplary embodiment of a turbomachine component 100 according to an aspect of the present technique. The turbomachine component 100 is implemented in the one or more of the overhangs 62,63,65,66 of the vane 44 or similar overhangs (not shown) of the platforms 39, 71, 72 of the turbine blade 38 and the guiding vane 40 of FIG. 2.

As shown in FIG. 4 in combination with FIG. 3, the turbomachine component 100, particularly a blade or a vane for the gas turbine engine 10, includes the aerofoil 110 and a first platform 120 extending axially and circumferentially i.e. the first platform 120 extends in an axial direction shown in FIG. 4 represented by an axis 98 and in a circumferential direction shown in FIG. 4 represented by an axis 97 mutually perpendicular to the axis 98 and an axis 99, wherein the axis 99 represents a radial direction. The aerofoil 110 includes a generally concave side also called pressure side 114, and a generally convex side also called suction side 116. The pressure side 114 and the suction side 116 meet at a trailing edge 112 and a leading edge 118. The first platform 120 is similar to the inner platform 61 of the vane 44 of FIG. 2.

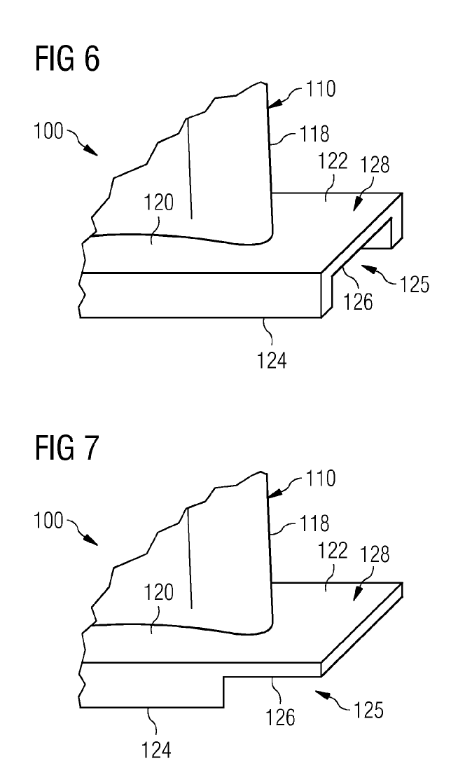

The first platform 120 has generally two sides along the radial direction 99 i.e. an aerofoil side 122 from which the aerofoil 110 extends radially and an opposite side 124 which is positioned towards the vane carrying ring 70 or the blade carrying disc 36 i.e. towards the rotational axis 20 when the turbomachine component 100, hereinafter also referred to as the component 100, is installed in the gas turbine engine 10, hereinafter also referred to as the gas turbine 10. The component 100 includes a first-platform cavity 125 positioned in a first overhang region 128 of the first platform 120. The first overhang region 128 may be understood as any of the overhangs 62,63,65,66 of the vane 44 of FIG. 2, although for the purposes of the present exemplary embodiment, the first overhang region 128 of FIG. 3 is similar to the overhang 62 of FIG. 2 i.e. when viewed from the leading edge 118 towards the trailing edge 112, the first overhang region 128 is present downstream of the trailing edge 112. However, in FIG. 4 the first overhang region 128 is similar to the overhang 63 of FIG. 2 i.e. when viewed from the trailing edge 112 towards the leading edge 118, the first overhang region 128 is present downstream of the leading edge 118. As shown in FIGS. 4, 6 and 7, the first-platform cavity 125 may have different configurations such as a rectangular cross-section as shown in FIG. 4, having four walls i.e. one wall along the side 122, another wall along the side 124, also called as the opposite-side cavity wall 127 (also shown in FIG. 3) and two side walls thereinbetween; or a semi-rectangular cross-section as shown in FIG. 6, having three walls i.e. one wall along the side 122 and two side walls; or may just have one wall along the side 122 as shown in FIG. 7.

As shown in FIGS. 3, 4, 6 and 7, the first-platform cavity 125 of FIG. 3 extends axially i.e. along the axis 98, and circumferentially i.e. along the axis 97, within the first platform 120 and includes an aerofoil-side cavity wall 126 along the aerofoil side 122. Within the first-platform cavity 125 a plurality of impingement plates 80 are arranged (not shown in FIGS. 4,6 and 7). The impingement plates 80 are arranged successively in an axial direction i.e. along the axis 98 and, each impingement plate 80 extends along the axial direction 98 and the circumferential direction 97 within the first-platform cavity 125. The cooling air or any other cooling fluid is fed into the first-platform cavity 125 through a cooling fluid channel 75 that in turns receives the cooling air or the other cooling fluid from the cooling passage 77 as shown in FIG. 3. The structure of the impingement plates 80 and the flow of the cooling air through the impingement plates 80 has been explained hereinafter later particularly with reference to FIG. 3 and FIGS. 14 to 18.

As shown in FIG. 5, the first platform 120 may also include an additional first-platform cavity 135 positioned in a second overhang region 129 of the first platform 120. The second overhang region 129 of the first platform 120 may be understood as the second overhang 63 of the inner platform 61 of the vane 44 as shown in FIG. 2. As shown in FIG. 5 in combination with FIG. 4, the second overhang region 129 is present downstream of the trailing edge 112, as shown in FIG. 5, when the first overhang region 128 is present upstream of the leading edge 118, as shown in FIG. 4. In other words, there may be only one platform cavity 125 in the first platform 120 and the platform cavity 125 may be present either downstream of the trailing edge 112 or upstream of the leading edge when viewed from the leading edge 118 towards the trailing edge 112, or may have two cavities 125, 135 whereby one is present downstream of the trailing edge 112 and other is present upstream of the leading edge 118 when viewed from the leading edge 118 towards the trailing edge 112. The additional first-platform cavity 135 extends circumferentially and axially within the first platform 120 and includes an aerofoil-side cavity wall 136 along the aerofoil side 122 and a plurality of impingement plates 80 arranged similarly as the impingement plates 80 are arranged in the first-platform cavity 125. The additional first-platform cavity 135 may include an opposite-side cavity wall 137 along the opposite side 124 of the first platform 120.

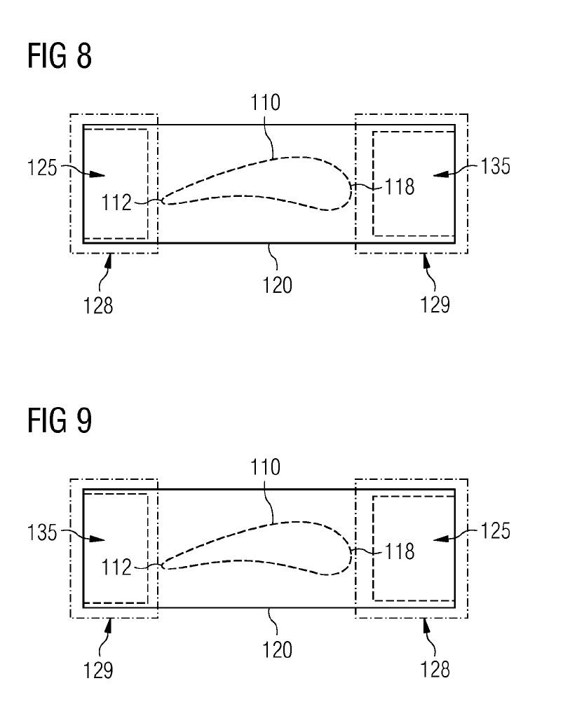

FIGS. 8 and 9 schematically represent the positions of the first-platform cavity 125 and the additional first-platform cavity 135 with respect to the aerofoil 110. As depicted in FIG. 8, in an exemplary embodiment of the component 100, the first overhang region 128 of the first platform 120 wherein the first-platform cavity 125 is present is downstream of the trailing edge 112 when viewed from the leading edge 118 in direction of the trailing edge 112, and the second overhang region 129 of the first platform 120 wherein the additional first-platform cavity 135 is located, when present, is upstream of the leading edge 118, when viewed from the leading edge 118 in direction of the trailing edge 112. In an alternate embodiment of the component 100, as depicted in FIG. 9, the first overhang region 128 of the first platform 120 wherein the first-platform cavity 125 is present is upstream of the leading edge 118 when viewed from the leading edge 118 in direction of the trailing edge 112, and the second overhang region 129 of the first platform 120 wherein the additional first-platform cavity 135 is located, when present, is downstream of the trailing edge 112, when viewed from the leading edge 118 in direction of the trailing edge 112.

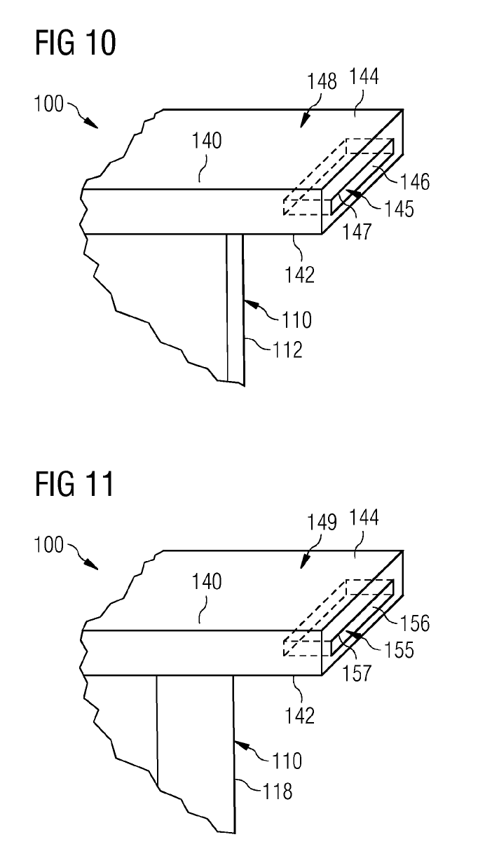

As shown in FIG. 10, the turbomachine component 100 may also include a circumferentially and axially extending second platform 140. The second platform 140 includes an aerofoil side 142 whereto the radially extending aerofoil 110 extends, an opposite side 144 of the aerofoil side 142, and a second-platform cavity 145 positioned in a first overhang region 148 of the second platform 140. The first overhang region 148 of the second platform 140 may be understood as the first overhang 65 of the outer platform 64 of the vane 44 as shown in FIG. 2. The second-platform cavity 145 extends axially and circumferentially within the second platform 140 and includes an aerofoil-side cavity wall 146 along the aerofoil side 142, and a plurality of impingement plates 80 arranged similarly as the impingement plates 80 are arranged in the first-platform cavity 125 of the first platform 120.

As shown in FIG. 11, the second platform 140 may also include an additional second-platform cavity 155 positioned in a second overhang region 149 of the second platform 140. The second overhang region 149 of the second platform 140 may be understood as the second overhang 66 of the outer platform 64 of the vane 44 as shown in FIG. 2. The additional second-platform cavity 155 extends circumferentially and axially within the second platform 140 and includes an aerofoil-side cavity wall 156 along the aerofoil side 142 and a plurality of impingement plates 80 arranged similarly as the impingement plates 80 are arranged in the first-platform cavity 125. The additional second-platform cavity 155 may include an opposite-side cavity wall 157 along the opposite side 144 of the second platform 140.

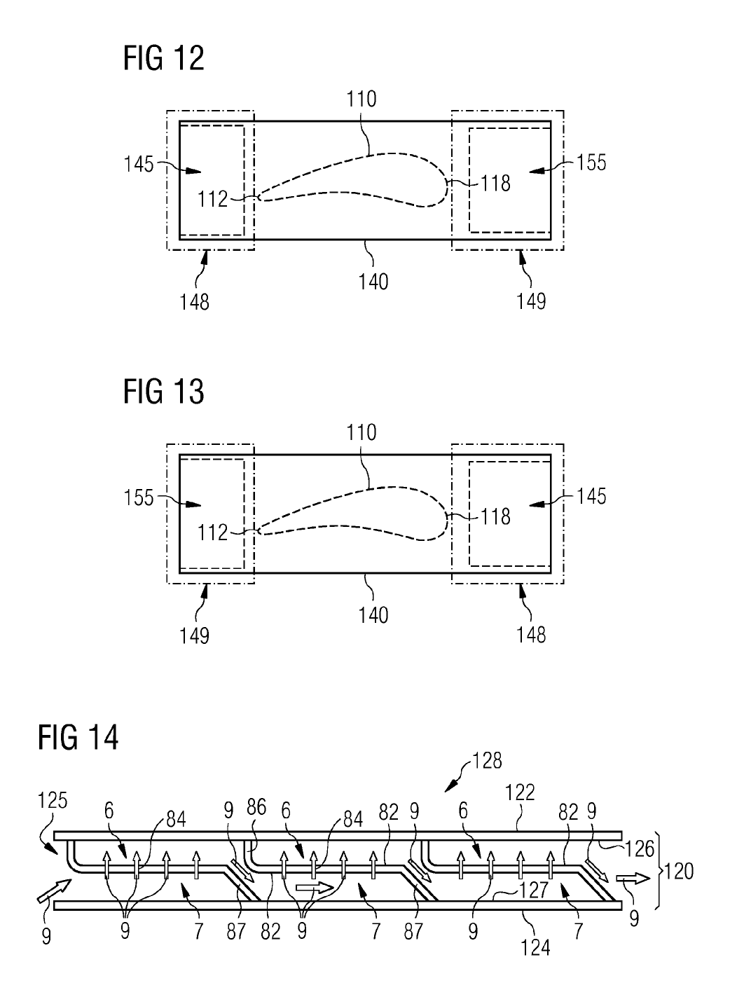

FIGS. 12 and 13 schematically represent the positions of the second-platform cavity 145 and the additional second-platform cavity 155 with respect to the aerofoil 110. As depicted in FIG. 12, in an exemplary embodiment of the component 100, the first overhang region 148 of the second platform 140 wherein the second-platform cavity 145 is present is downstream of the trailing edge 112 when viewed from the leading edge 118 in direction of the trailing edge 112, and the second overhang region 149 of the second platform 140 wherein the additional second-platform cavity 155 is located, when present, is upstream of the leading edge 118, when viewed from the leading edge 118 in direction of the trailing edge 112. In an alternate embodiment of the component 100, as depicted in FIG. 13, the first overhang region 148 of the second platform 140 wherein the second-platform cavity 145 is present is upstream of the leading edge 118 when viewed from the leading edge 118 in direction of the trailing edge 112, and the second overhang region 149 of the second platform 140 wherein the additional second-platform cavity 155 is located, when present, is downstream of the trailing edge 112, when viewed from the leading edge 118 in direction of the trailing edge 112.

Hereinafter, the impingement plates 80 and the flow of the cooling air within the cavities 125, 135, 145, 155 is explained. The flow of the cooling air within the cavities 125, 135, 145, 155 has been depicted by arrows marked with reference numeral 9.

As shown in FIGS. 3 and 14, the component 100 further includes the plurality of impingement plates 80. The impingement plates 80 are successively arranged in the axial direction within the first-platform cavity 125, i.e. along the axis 98 of FIG. 4. It may be noted that FIGS. 3 and 14 represent cross-sectional views of the component 100 which has three impingement plates 80 serially arranged and spanning different sections of the first-platform cavity 125. However, the three impingement plates 80 depicted in FIGS. 3 and 14 are only for exemplary purposes and the component 100 may include impingement plates 80 which are more than or less than three.

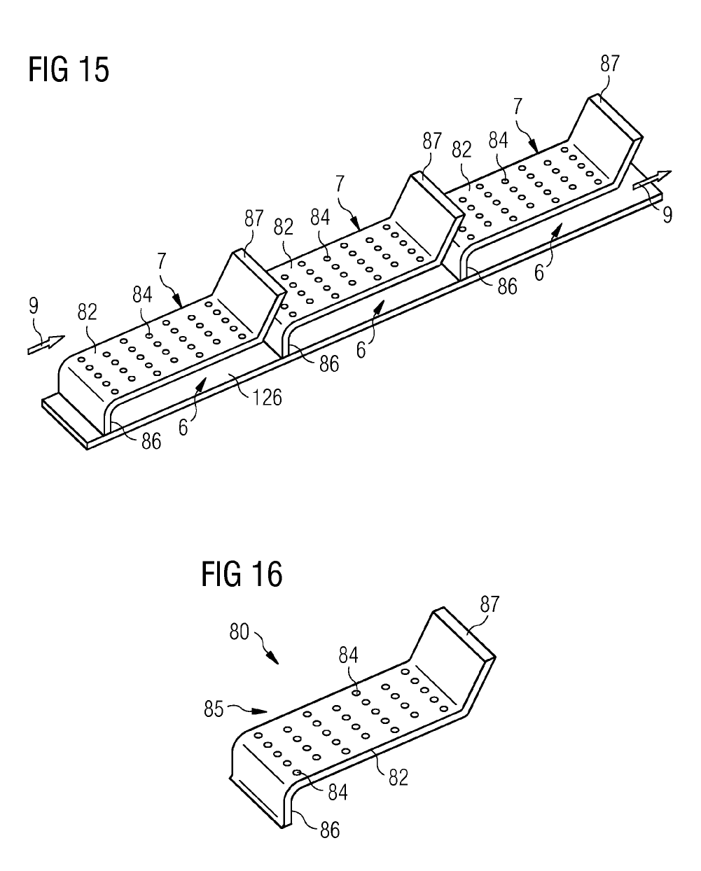

As depicted in FIGS. 15 to 17 in combination with FIGS. 3 and 14, each impingement plate 80 includes an aerofoil-side part 86, a flow-input-side part 87 and a central plate 82 structurally in-between the aerofoil-side part 86 and the flow-input-side part 87. The aerofoil-side part 86 extends towards and is connected to the aerofoil-side cavity wall 126 of the first-platform cavity 125. The flow-input-side part 87 extends towards a direction opposite to the aerofoil-side cavity wall 126 of the first-platform cavity 125 and may be connected to the opposite-side cavity wall 127 or to a part of the vane carrying ring 70 when the opposite-side cavity wall 127 is not present. The central plate 82 is suspended by the aerofoil-side part 86 and the flow-input-side part 87 in the first-platform cavity 125 such that the central plate 82 extends along the aerofoil-side cavity wall 126. The parts 86 and 87 may be connected or joint or fixedly attached to the wall 126 and the wall 127, respectively, and may even be connected or positioned by interference fit.

As a result of attaching the part 86 to the wall 126 and the part 87 to the wall 127 or a part of the vane carrying ring 70, the central plate 82 between the part 86 and the part 87 is suspended in the first-platform cavity 125. Referring again to FIGS. 14 and 15, spatial arrangement of the central plate 82 within the first-platform cavity 125 is depicted. As a result of suspension of the central plate 82 in first-platform cavity 125, hereinafter also referred to the cavity 125, and connection of the part 86 and the part 87 to the wall 126 and the wall 127 or a part of the vane carrying ring 70, respectively, each impingement plate 80 divides a section of the cavity 125 and thus defines within the cavity 125, in the radial direction 99, an aerofoil-side segment 6 or compartment 6 and a flow-input-side segment 7 or compartment 7. In other words, one segment 6 and one segment 7 are created by each of the impingement plates 80 and are said to be corresponding to the impingement plate 80 that creates said segment 6 and said segment 7.

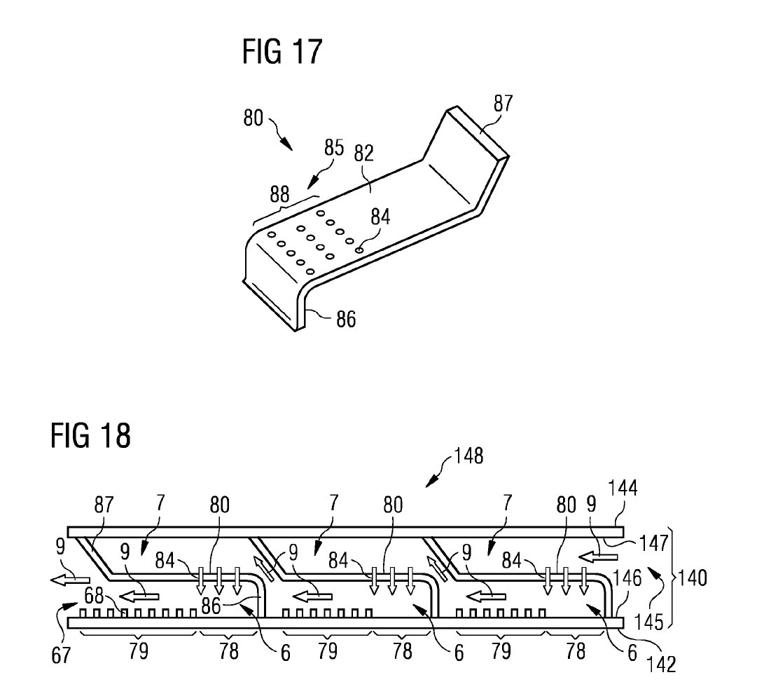

The central plate 82 has impingement holes 84 as depicted in FIGS. 16 and 17. In the central plate 82 the impingement holes 84 are located as the array 85. The array 85 may span entire area of the central plate 82 between the part 86 and the part 87, as shown in FIG. 16. Alternatively, the array 85 may not span the entire expanse of the central plate 82 and may be limited to a portion of the central plate 82 for example a region 88 of the central plate 82. As shown in FIG. 14, the cooling air entering the first-platform cavity 125 flows within the first-platform cavity 125 from the flow-input-side segment 7 of one impingement plate 80 through the impingement holes 84 to the aerofoil-side segment 6 of said impingement plate 80 as impingement jets, and then from the aerofoil-side segment 6 of said impingement plate 80 to the flow-input-side segment 7 of a following impingement plate 80. From the flow-input-side segment 7 of the following impingement plate 80 the cooling air flows through the impingement holes 84 of said following impingement plate 80 as impingement jets towards the aerofoil-side cavity wall 146 of the first-platform cavity 125 and therefrom to the flow-input-side segment 7 of a subsequent following impingement plate 80, and so on and so forth.

Similarly for the impingement plates 80 arranged in the additional first-platform cavity 135, the aerofoil-side part 86 of the impingement plate 80 extending towards and is connected to the aerofoil-side cavity wall 136 of the additional first-platform cavity 135; and the flow-input-side part 87 extends towards a direction opposite to the aerofoil-side cavity wall 136 of the additional first-platform cavity 135 and is connected to the opposite-side cavity wall 137 or to a part of the vane carrying ring 70. The impingement plates 80 are similarly arranged in the additional first-platform cavity 135 as explained for the impingement plates 80 arranged in the first-platform cavity 125 and create similarly the segments 6 and 7 and have a direction of flow of cooling air similar to that of the direction of flow of cooling air explained hereinabove for FIG. 14, i.e. from the segment 7 towards the segment 6 for a corresponding impingement plate 80.

FIG. 18 schematically depicts the impingement plates 80 arranged in the second-platform cavity 145. The impingement plates 80 are successively arranged in the axial direction 98 within the second-platform cavity 145, with the aerofoil-side part 86 extending towards and connected to the aerofoil-side cavity wall 146 of the second-platform cavity 145 and the flow-input-side part 87 extending towards and connected to the opposite-side cavity wall 147 or to another stationary part of the stator 42 when the opposite-side cavity wall 147 is not present. As a result of attaching the part 86 to the wall 146 and the part 87 to the wall 147, the central plate 82 between the part 86 and the part 87 is suspended in the second-platform cavity 145, and as a result of suspension of the central plate 82 in second-platform cavity 145, hereinafter also referred to the cavity 145, and connection of the part 86 and the part 87 to the wall 146 and the wall 147, respectively, each impingement plate 80 divides a section of the cavity 145 and thus defines within the cavity 145, in the radial direction 99, the segment 6 and the segment 7 similar to the segment 6, 7 explained hereinabove with reference to FIGS. 3 and 14. The flow of cooling air within the cavity 145 is similar to the flow of cooling air explained hereinabove with reference to FIGS. 3 and 14.

Similarly for the impingement plates 80 arranged in the additional second-platform cavity 155, the aerofoil-side part 86 of the impingement plate 80 extends towards and is connected to the aerofoil-side cavity wall 156 of the additional second-platform cavity 155; and the flow-input-side part 87 extends towards and is connected to the opposite-side cavity wall 157. The impingement plates 80 are similarly arranged in the additional second-platform cavity 155 as explained for the impingement plates 80 arranged in the first-platform cavity 125 and create similarly the segments 6 and 7 and have a direction of flow of cooling air similar to that of the direction of flow of cooling air explained hereinabove for FIG. 14, i.e. from the segment 7 towards the segment 6 for a corresponding impingement plate 80.

Furthermore, referring to FIG. 18 another embodiment of the component 100 has been explained. The component 100 includes an array 67 of turbulators 68 positioned on the aerofoil-side cavity wall 146. The component 100 may also includes an array 67 of turbulators 68 positioned on the aerofoil-side cavity walls 136, 146 and 156. The turbulators 68 increase the turbulence in the cooling air when the cooling air passes over the aerofoil-side cavity wall 126,136,146,156 having the turbulators 68. The turbulators 68 depicted in FIG. 18 are rib shaped. However, it may be noted that it is well within the scope of the present technique, that the turbulators 68 may have variety of different shapes, for example but not limited to split-rib shaped i.e. rib shapes that are split, wedge shaped, split-wedge shaped, pin fin shaped i.e. cylindrical individual protrusions, conical shaped, conical frustum shaped, spherical dome shaped, tetrahedron shaped, tetrahedral frustum shaped, pyramidal shaped, and pyramidal frustum shaped.

FIG. 18 depicts the turbulators 68 to be limited to a part 79 of the aerofoil-side cavity wall 146 whereas another part 78 of the aerofoil-side cavity wall 146 is free of the turbulators 68, however, the turbulators 68 may be present over the entire expanse of the aerofoil-side cavity wall 126 within the cavity 145.

In an exemplary embodiment of the component 100, one or more of the cavities 125,135,145,155 is completely limited to the overhang regions 128,129,148,149, respectively does not extend to the part of the platforms 120,140 that are directly beneath or above the aerofoil 110. The advantage is that the cooling air directed to the aerofoil cavity through the part of the platforms 120,140 that are directly beneath or above the aerofoil 110 is not affected by the flow of the cooling air into the cavities 125,135,145,155. The cooling air after flowing through the cavities 125,135,145,155 is exited in the hot gas flow path from the platform 120,140 directly or into a rim seal cavity 73 as depicted in FIG. 3.

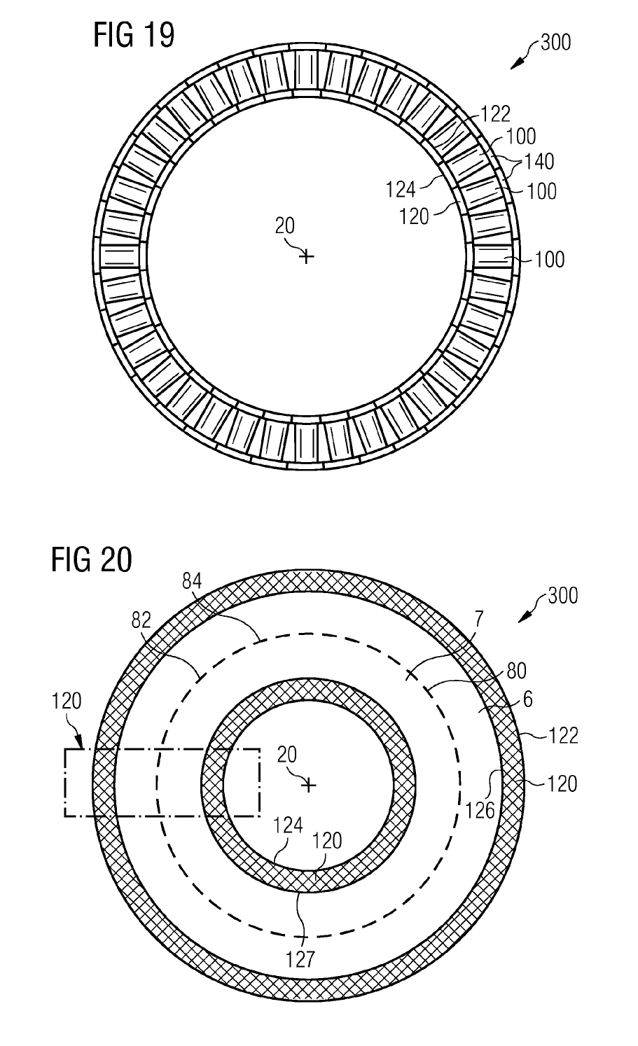

Referring now to FIGS. 19 and 20, another aspect of the present technique is described according to which an array 300 of turbomachine components such as the turbine vanes 44, 40 or the turbine blades 38 is presented. The array 300 includes a plurality of turbomachine components such as the turbine vanes 44, 40 or the turbine blades 38 and a turbomachine components carrying ring such as the vane carrying ring 70 or the blade carrying disc 36. The turbine vanes 44, 40 or the turbine blades 38 are circumferentially arranged on the vane carrying ring 70 or the blade carrying disc 36, respectively to form a circular array around the rotational axis 20. The plurality of the turbine vanes 44, 40 or the turbine blades 38 includes at least one turbomachine component 110 according to the aspect of the present technique presented hereinabove with reference to FIGS. 2 to 17.

An advantage of the present cooling arrangement is that it is compact and can provide a thin impingement cooling arrangement. In other words, the present cooling arrangement is thin or has a relatively small thickness in a direction perpendicular to the plane of the surface or wall 126 being cooled. This is particularly helpful in applications such as a blade or vane where thicknesses of parts, such as wall 126 defining a gas-washed surface, are important to minimize aerodynamic losses. The thickness or the distance between the walls 126 and 127 can be a minimum whilst maintaining sufficient impingement cooling. Thus for the platform 120 shown in FIG. 14 the blade's aerodynamics are not compromised, there is minimal weight increase and the surrounding engine architecture is unaffected so the blade can fit into the existing space provided and can be retrofitted.

Another advantage of the present arrangement is that the distance from the central plate 82 to the cooled wall 126 may be an optimum distance for maximum impingement cooling effect for the impingement cooling jets. The central plate 82 may be located nearer to the wall 126, on to which the impingement jets strike, than the wall 127. In other examples, the central plate 82 may be located nearer to the wall 127 than the wall 126. Thus the wall 126 may be optimally cooled. Bespoke cooling arrangements are then possible for many different applications of the present invention. For optimum cooling the impingement jets' effectiveness can be dependent on the pressure of the cooling fluid, the size of the impingement hole and the distance from the impingement hole in the central plate 82 to the target surface such as the wall 126.

Furthermore, each consecutive impingement plate 80 may have its central plate 82 located at a different distance from the cooled wall 126 compared to one or more of the other central plates 82. The different distances of each central plate 82 may be dependent on a number of factors such as the pressure of the cooling air 9 immediately adjacent each central plate 82 and/or the temperature of the wall 126 and/or the temperature of the cooling air 9. For example, and with respect to the direction of the cooling flow 9, a first central plate 82 is a first distance away from the cooled wall 126 and a downstream central plate 82 is a second distance from the cooled wall 126; the second distance is smaller than the first distance. Further, each consecutive central plate 82, after the first central plate 82, may be closer to the cooled wall 126 than its immediately upstream neighbour. In another example, the second distance from the cooled wall 126 is greater than the first distance. Further, each consecutive central plate 82, after the first central plate 82, may be further from the cooled wall 126 than its immediately upstream neighbour.

Yet further the two walls 126, 127 may not be parallel and may converge or diverge such that the aerofoil-side part 86 and the flow-input-side part 87 are different lengths. Thus, where the two walls 126, 127 are converging or diverging the central plate 82 may be parallel to the cooled wall 126 and not parallel to the wall 127. Alternatively, the central plate 126 may converge or diverge with respect to the cooled wall 126.

It should be appreciated that two, three or more impingement plates 80 may be sequentially or consecutively located to use and reuse cooling air 9.

In the present disclosure, orientation terms such as “radial”, “inner”, “outer”, “circumferential”, “beneath” “below” and the like are to be taken relative to a turbine axis i.e. the rotational axis 20. “Inner” means radially inner, or closer to the rotational axis 20, whereas “outer” means radially outer, or away from the rotational axis 20.

While the present technique has been described in detail with reference to certain embodiments, it should be appreciated that the present technique is not limited to those precise embodiments. Rather, in view of the present disclosure which describes exemplary modes for practicing the invention, many modifications and variations would present themselves, to those skilled in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

1. A turbomachine component, comprising:
an aerofoil having a pressure side and a suction side, wherein the pressure side and the suction side meet at a trailing edge and a leading edge;
a first platform comprising an aerofoil side wherefrom the aerofoil extends radially, an opposite side of the aerofoil side, and a first-platform cavity positioned in a first overhang region of the first platform, wherein the first-platform cavity extends within the first platform and comprises an aerofoil-side cavity wall along the aerofoil side, and
a plurality of impingement plates arranged successively along an axial direction within the first-platform cavity, wherein each of the impingement plates comprises:
an aerofoil-side part extending towards and connected to the aerofoil-side cavity wall of the first-platform cavity;
a flow-input-side part extending towards a direction opposite to the aerofoil-side cavity wall of the first-platform cavity; and
a central plate between the aerofoil-side part and the flow-input-side part;
wherein the central plate is suspended by the aerofoil-side part and the flow-input-side part in the first-platform cavity extending along the aerofoil-side cavity wall such that the impingement plate defines, within the first-platform cavity in a radial direction, an aerofoil-side segment and a flow-input-side segment corresponding to said impingement plate and wherein the central plate comprises impingement holes such that cooling air entering the first-platform cavity is adapted to flow within the first-platform cavity from the flow-input-side segment of one impingement plate through the impingement holes to the aerofoil-side segment of said impingement plate and therefrom to the flow-input-side segment of a following impingement plate.

2. The turbomachine component according to claim 1,
wherein the first-platform cavity comprises an opposite-side cavity wall along the opposite side of the first platform, and wherein the flow-input-side part of the impingement plate arranged within the first-platform cavity is connected to the opposite-side cavity wall.

3. The turbomachine component according to claim 1,
wherein the first platform comprises an additional first-platform cavity positioned in a second overhang region of the first platform, wherein the additional first-platform cavity extends within the first platform and comprises an aerofoil-side cavity wall along the aerofoil side, and
a plurality of impingement plates arranged successively along the axial direction within the additional first-platform cavity, wherein each of the impingement plates comprises:
an aerofoil-side part extending towards and connected to the aerofoil-side cavity wall of the additional first-platform cavity;
a flow-input-side part extending towards a direction opposite to the aerofoil-side cavity wall of the additional first-platform cavity; and
a central plate between the aerofoil-side part and the flow-input-side part
wherein the central plate is suspended by the aerofoil-side part and the flow-input-side part in the additional first-platform cavity extending along the aerofoil-side cavity wall of the additional first-platform cavity such that the impingement plate defines, within the additional first-platform cavity in the radial direction, an aerofoil-side segment and a flow-input-side segment corresponding to said impingement plate and wherein the central plate comprises impingement holes such that cooling air entering the additional first-platform cavity is adapted to flow within the additional first-platform cavity from the flow-input-side segment of one impingement plate through the impingement holes to the aerofoil-side segment of said impingement plate and therefrom to the flow-input-side segment of a following impingement plate.

4. The turbomachine component according to claim 3,
wherein the additional first-platform cavity comprises an opposite-side cavity wall along the opposite side of the first platform, and wherein the flow-input-side part of the impingement plate arranged within the additional first-platform cavity is connected to the opposite-side cavity wall.

5. The turbomachine component according to claim 3
wherein the first overhang region of the first platform is downstream of the trailing edge when viewed from the leading edge towards the trailing edge or is downstream of the leading edge when viewed from the trailing edge towards the leading edge.

6. The turbomachine component according to claim 5,
wherein the second overhang region of the first platform is upstream of the leading edge, when the first overhang region of the first platform is downstream of the trailing edge, or is upstream of the trailing edge, when the first overhang region of the first platform is downstream of the leading edge.

7. The turbomachine component according to claim 1, further comprising:
a second platform, wherein the second platform comprises an aerofoil side whereto the radially extending aerofoil extends, an opposite side of the aerofoil side, and a second-platform cavity positioned in a first overhang region of the second platform, wherein the second-platform cavity extends within the second platform and comprises an aerofoil-side cavity wall along the aerofoil side, and
a plurality of impingement plates arranged successively along the axial direction within the second-platform cavity, wherein each of the impingement plates comprises:
an aerofoil-side part extending towards and connected to the aerofoil-side cavity wall of the second-platform cavity;
a flow-input-side part extending towards a direction opposite to the aerofoil-side cavity wall of the second-platform cavity; and
a central plate between the aerofoil-side part and the flow-input-side part
wherein the central plate is suspended by the aerofoil-side part and the flow-input-side part in the second-platform cavity extending along the aerofoil-side cavity wall such that the impingement plate defines, within the second-platform cavity in the radial direction, an aerofoil-side segment and a flow-input-side segment corresponding to said impingement plate and wherein the central plate comprises impingement holes such that cooling air entering the second-platform cavity is adapted to flow within the second-platform cavity from the flow-input-side segment of one impingement plate through the impingement holes to the aerofoil-side segment of said impingement plate and therefrom to the flow-input-side segment of a following impingement plate.

8. The turbomachine component according to claim 7,
wherein the second-platform cavity comprises an opposite-side cavity wall along the opposite side of the second platform, and wherein the flow-input-side part of the impingement plate arranged within the second-platform cavity is connected to the opposite-side cavity wall.

9. The turbomachine component according to claim 7,
wherein the second platform comprises an additional second-platform cavity positioned in a second overhang region of the second platform, wherein the additional second-platform cavity extends within the second platform and comprises an aerofoil-side cavity wall along the aerofoil side, and
a plurality of impingement plates arranged successively along the axial direction within the additional second-platform cavity, wherein each of the impingement plates comprises:
an aerofoil-side part extending towards and connected to the aerofoil-side cavity wall of the additional second-platform cavity;
a flow-input-side part extending towards a direction opposite to the aerofoil-side cavity wall of the additional second-platform cavity; and
a central plate between the aerofoil-side part and the flow-input-side part
wherein the central plate is suspended by the aerofoil-side part and the flow-input-side part in the additional second-platform cavity extending along the aerofoil-side cavity wall of the additional second-platform cavity such that the impingement plate defines, within the additional second-platform cavity in the radial direction, an aerofoil-side segment and a flow-input-side segment corresponding to said impingement plate and wherein the central plate comprises impingement holes such that cooling air entering the additional second-platform cavity is adapted to flow within the additional second-platform cavity from the flow-input-side segment of one impingement plate through the impingement holes to the aerofoil-side segment of said impingement plate and therefrom to the flow-input-side segment of a following impingement plate.

10. The turbomachine component according to claim 9,
wherein the additional second-platform cavity comprises an opposite-side cavity wall along the opposite side of the second platform, and wherein the flow-input-side part of the impingement plate arranged within the additional second-platform cavity is connected to the opposite-side cavity wall.

11. The turbomachine component according to claim 7,
wherein the first overhang region of the second platform is downstream of the trailing edge when viewed from the leading edge towards the trailing edge or is downstream of the leading edge when viewed from the trailing edge towards the leading edge.

12. The turbomachine component according to claim 11,
wherein the second overhang region of the second platform is upstream of the leading edge, when the first overhang region of the second platform is downstream of the trailing edge, or is upstream of the trailing edge, when the first overhang region of the second platform is downstream of the leading edge.

13. An array of turbomachine components for a gas turbine, wherein the array comprises comprising:
a plurality of turbomachine components having aerofoils and a turbomachine components carrying ring,
wherein each of the turbomachine components having aerofoils is circumferentially arranged on the turbomachine components carrying ring and
wherein the plurality of turbomachine components having aerofoils comprises at least one turbomachine component according to claim 1.

14. The array according to claim 13,
wherein the turbomachine components having aerofoils are blades for the gas turbine and wherein the turbomachine components carrying ring is a rotor disc for the gas turbine.

15. The array according to claim 13,
wherein the turbomachine components having aerofoils are vanes of the gas turbine engine and wherein the turbomachine components carrying ring is a vane carrier ring of the gas turbine engine.

16. The turbomachine component according to claim 1,
wherein the turbomachine component is adapted for a blade or a vane for a gas turbine engine.
